(19) United States
(12) Patent Application Publication
(10) Pub. No.: US 2005/0079353 A1
(43) Pub. Date: Apr. 14, 2005

(54) Reduction of electromagnetic radiation

(75) Inventors: Thomas William Harper, Middlesbrough (GB); Kenneth Gerand Patton, Stockton-on-Tees (GB); David Julian Lax, Stockton-on-Tees (GB); Colin Thomas Metcalfe, Middlesbrough (GB)

Correspondence Address: WATTS HOFFMANN CO., L.P.A., Ste. 1750, 1100 Superior Avenue, Cleveland, OH, 44114, US

(73) Assignee: IDA (EMC) Limited

(21) Appl. No.: 10/843,245

(22) Filed: May 11, 2004

(30) Foreign Application Priority Data
Nov. 14, 2002 (WO) PCT/GB02/05168
Nov. 14, 2001 (GB) 12732.0

(51) Int. Cl. B32B 27/20; B32B 1/00

(52) U.S. Cl. 428/407; 523/205; 523/216

(57) ABSTRACT

A filler for plastics or elastomeric materials comprising a powder having a ferromagnetic material content greater than 20% by weight and a silica content greater than 20% by weight, the powder being coated with an electro-conductive metallic material. The filler is designed to provide shielding for electromagnetic radiation.

The present invention relates to the reduction of electromagnetic radiation by means of shielding.

The increased pervasion and invasion of electromagnetic radiation in modern society has caused increasing interference between electronic and micro-electronic devices and may result in loss of security, interference between devices and may be a health hazard. Thus shielding may be required for both incoming and outgoing radiation. Large spaces, such as whole rooms, are commonly shielded by Faraday cages or shields comprising of an earthed metal screen around the space. These may be heavy, expensive and difficult to install. Small spaces such as enclosures are commonly shielded by aluminium, steel or metal coated plastics that are heavy, difficult to form, are vulnerable to damage or are expensive. It is an object of the invention to provide shielding against electromagnetic radiation which is adaptable to both large and tiny spaces and for electronic components or circuits.

Other objects of the invention will be set out herebelow.

According to one aspect of the invention there is provided a filler for plastics or elastomeric materials comprising a powder having a ferromagnetic material content greater than 20% by weight and a silica content greater than 20% by weight, the powder being coated with an electro-conductive metallic material.

The filler of the invention may be used in a plastic or elastomeric material to provide a very efficient form of shielding.

The efficiency of the shielding of the invention is such that at high attenuation of electro-magnetic transmissions, shielding is obtained for a small thickness of material of the invention. For example, a thickness of about 4 mm of the compounded material has achieved a 90 dB reduction of radiation at up to frequencies of several GHz. When the material is provided in sheet form large areas of ceilings and walls can be covered by merely applying the sheets to an existing structure and securing with a suitable adhesive.

Preferably the powder is compounded with the polymer or elastomeric material in a proportion of over 50% by weight.

When shielding small components such as microchips it has been found that the shielding of the invention is readily applied to the microchips in the form of packaging. Surprisingly it has been found that electrical conductivity between wires to the microchips within the package is negligible.

It has also been found that heat dissipation appears to be improved when using the material of the invention within the package of the microchip. Similar behaviour is applicable when the invention is used to package electronic circuits.

The powdered oxide is conveniently provided in the form of the IDA 2000 powder, which is a proprietary powder product of the applicant/assignee company, of by weight about 2.0% CaO, 25-50% SiO₂, 1.1% FeO, Fe₂O₃ or Fe₃ O₄, 1.35% ZnO, 1.7% SC₃, and small amounts (less than 1%) of oxides such as MnO, K₂O, PbO, Cr₂O₃ and/or TiO₂. IDA 2000 contains a healthy distribution of oxides, magnetic and electrical materials with other useful ingredients for fillers to be used in transfer moulded plastic packages. Although some ionic materials are present, these are rendered innocuous within their oxides. Halides are absent. When using IDA 2000 no levels of alpha particle emissions above background have been detected in over 1000 hours for energies in the range 1 to 8 MeV. The measured conductivity of IDA 2000 when compressed is a matter of megohms. When used as a filler IDA 2000 may be dispersed in an uncompressed form at concentrations of between 70% and 95% by weight which results in a conductivity of nearing 10⁹ Ohms. The coefficient of expansion of IDA 2000 has been found to be significantly less than the maximum value of 15×10⁶ which is currently required for micro-electronic transfer moulded packages.

Another object of the invention is to provide a mouldable plastic product that can be readily plated.

Further aspects of the invention are the products of plastics or elastomeric materials using the filler of the invention that may be plated.

IDA 2000 as obtained from the Applicant is a waste product of an industrial process and hence is economical to use.

Embodiments of the present invention will now be described by way of example with reference to the accompanying drawings and a graph in which:

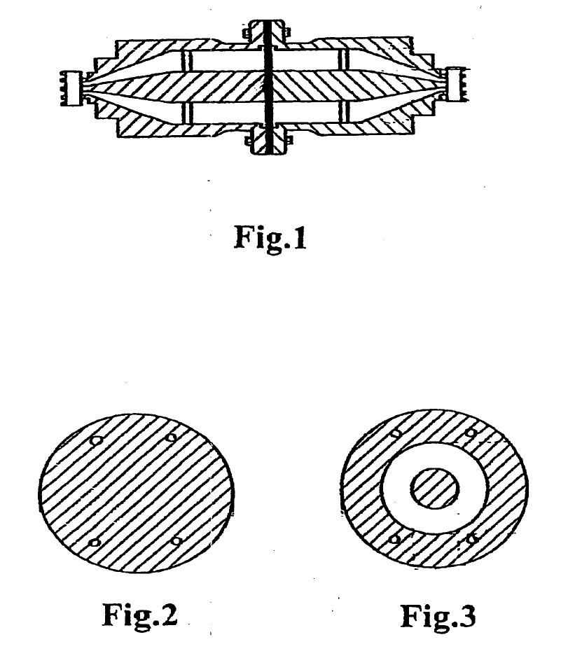

FIG. 1 is a longitudinal cross-section of a co-axial cavity test device loaded with a sample of shielding according to the invention.

FIG. 2 is a transverse elevation of a sample of shielding according to the invention for loaded measurement within the test device of FIG. 1.

FIG. 3 is a transverse elevation of a sample of shielding for the unloaded measurement within the test device of FIG. 1.

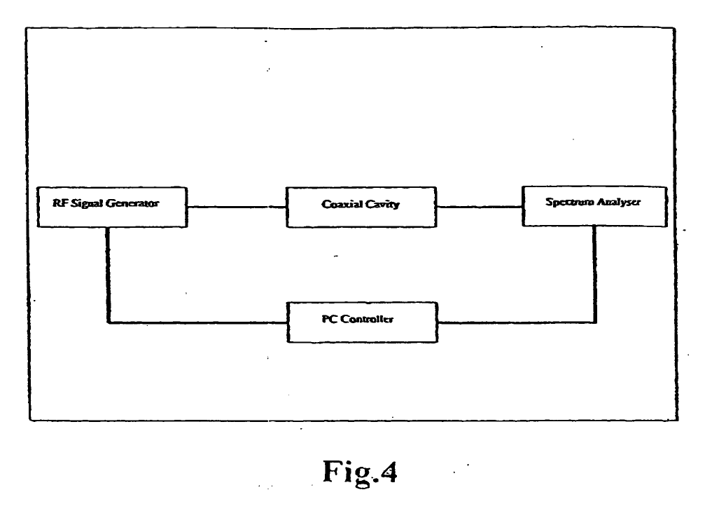

FIG. 4 is a block diagram of a test rig using the test device of FIG. 1.

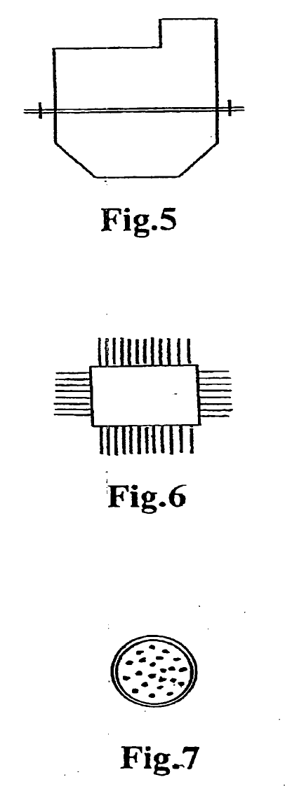

FIG. 5 shows a typical box to enclose electronic circuitry shielded according to the invention.

FIG. 6 shows a typical semi-conductor package shielded according to the invention.

FIG. 7 is a cross-section for a cable shielded according to the invention.

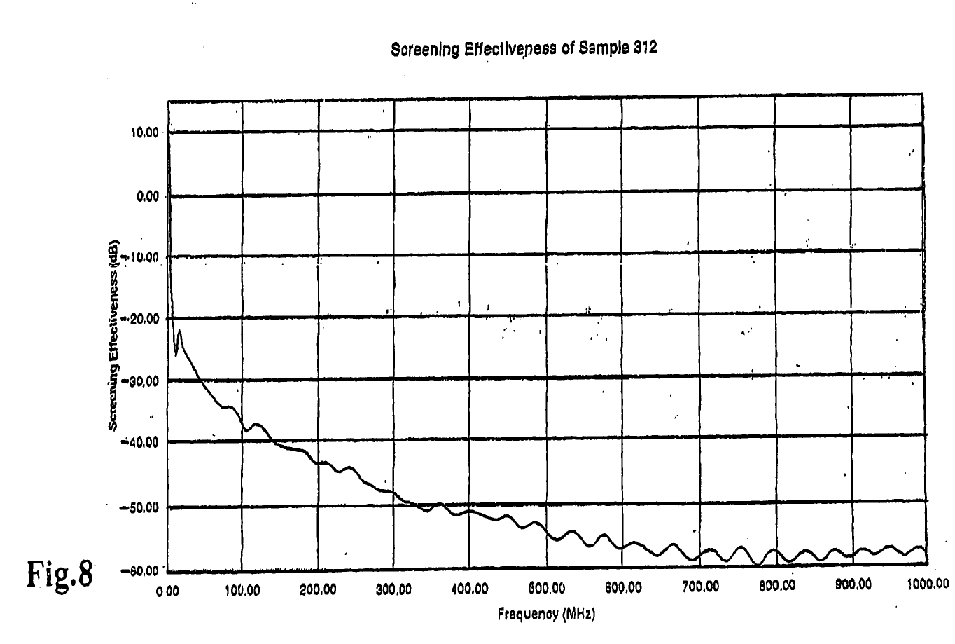

FIG. 8 is a graph showing screening effectiveness of the shielding according to the invention in a typical test result using the device and rig of FIGS. 1 to 4.

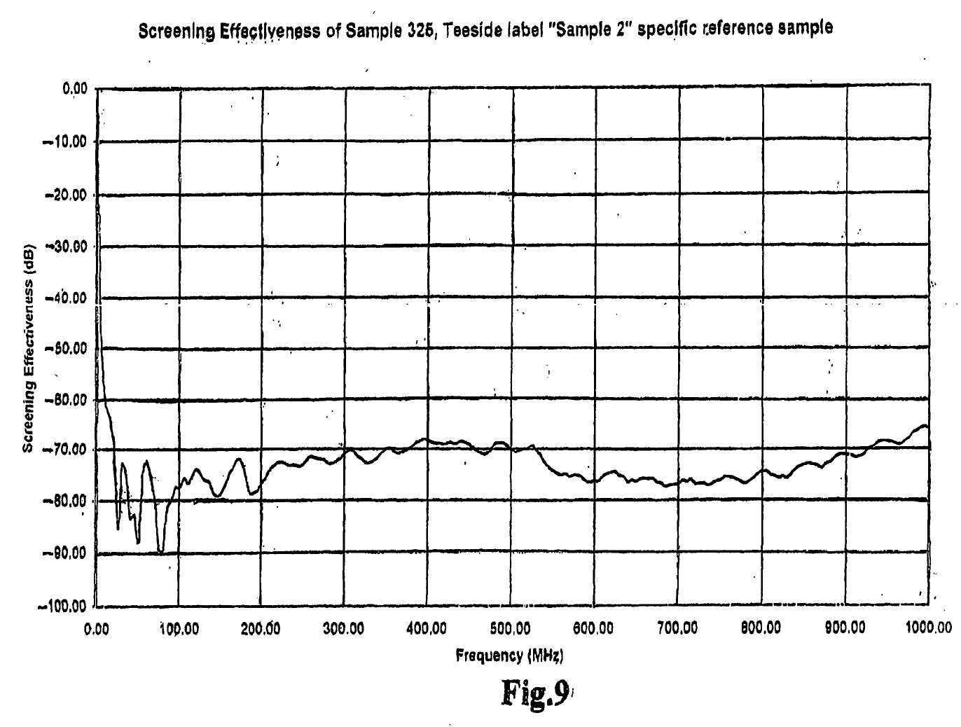

FIG. 9 is a graph showing screening effectiveness using a 1 to 2 micron copper coated Myranite powder filler according to the invention.

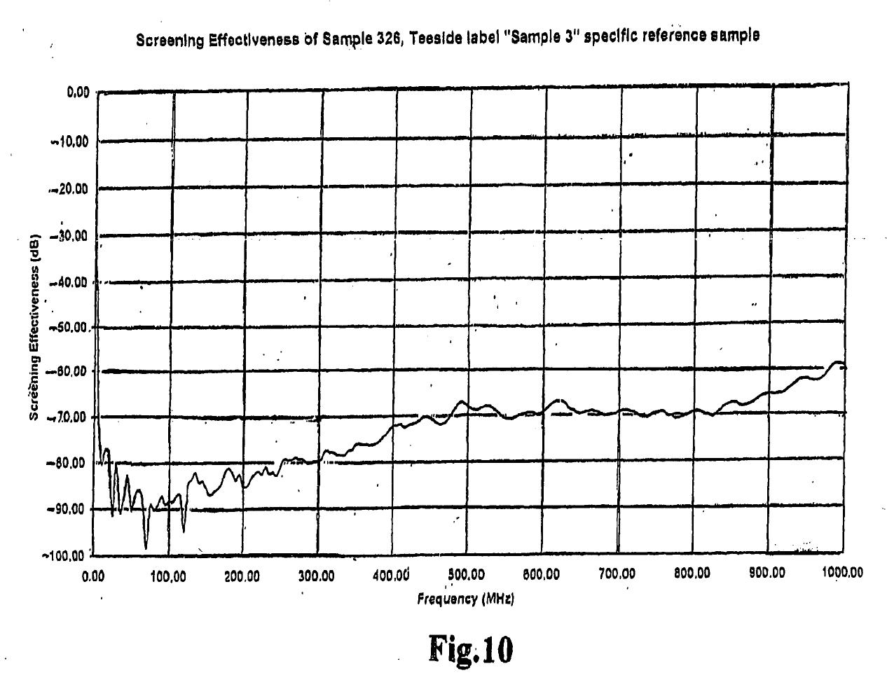

FIG. 10 is a graph showing screening effectiveness using a 2 to 3 micron copper coated Myranite powder filler according to the invention.

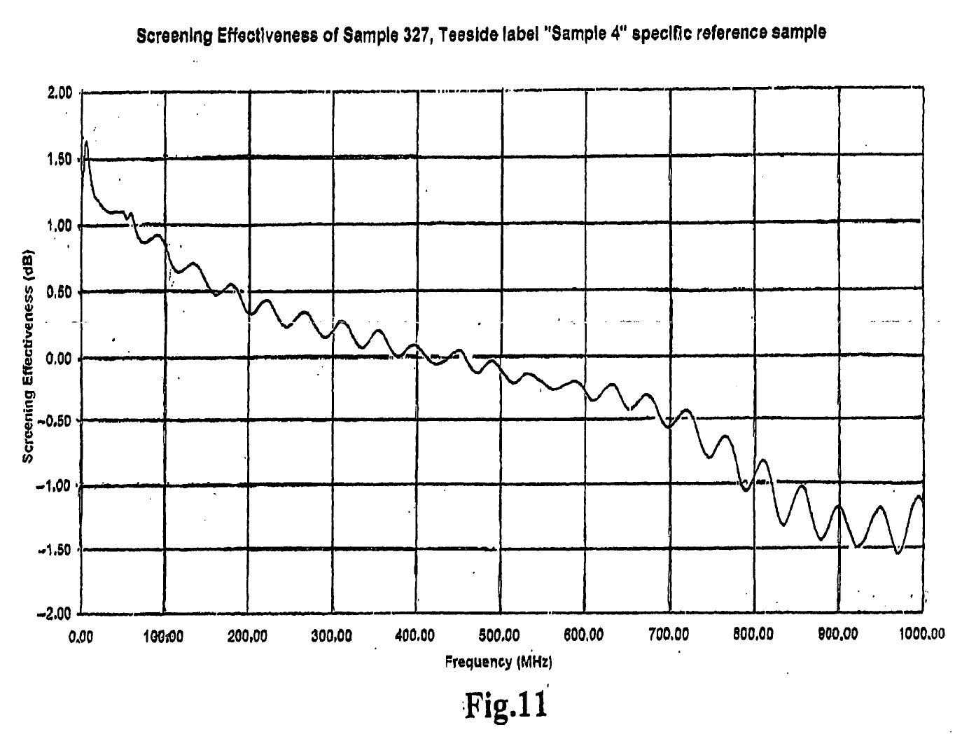

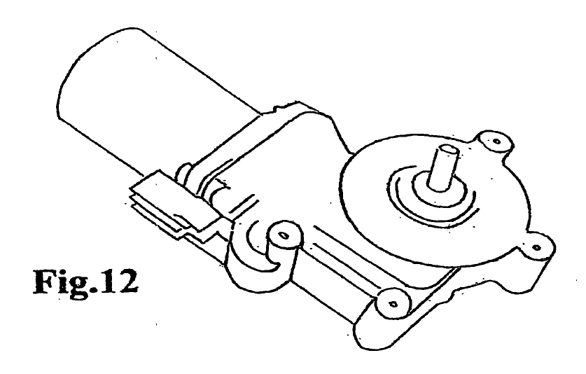

FIG. 11 is a graph showing the screening ineffectiveness using a standard known filler by way of comparison with the tests shown in FIGS. 9 and 10, and

FIG. 12 shows a windscreen wiper motor formed from plastics material according to the invention.

Shielding formed using Myranite powder coated with copper in several examples with different percentages by weight of Myranite as shown in Table 1 below was compressed into discs 133 mm in diameter and approximately 4 mm thick and fitted into the test device of FIG. 1.

TABLE 1

| | | % Contents | |
|---|---|---|---|
| Symbol | Name | Sample 1 | Sample 2 |
| Fe | Iron as FeO, Fe₂O₃, Fe₃O₄ | 25 to 50 | 25 to 50 |
| SiO₂ | Silica | 25 to 50 | 25 to 50 |
| CaO | Calcium Oxide | 2.5 | 9.0 |
| MgO | Magnesium Oxide | 1.1 | — |
| Al₂O₃ | Aluminium Oxide | 4.4 | 4.5 |
| K₂O | Potassium Oxide | 0.52 | 0.1 |
| Sn | Tin | — | 0.2 |
| Zn | Zinc as Zinc Oxide (ZnO) | 1.35 | 4.0 |
| S | Sulphur as Sulphur Oxide (SO₃) | 1.7 | <0.2 |
| Mn | Manganese | — | 0.5 |
| MnO | Manganese Oxide | 0.3 | 1.9 |
| Pb | Lead as Lead Oxide (PbO) | 0.2 | 0.3 |
| P₂O₅ | Phosphorus Pentoxide | — | <0.2 |
| Bi | Bismuth | — | <0.1 |
| Cr₂O₃ | Chrome as Chrome Oxide (Cr₂O₃) | 0.15 | Trace < 0.1 |
| Cd | Cadmium | — | Trace < 0.1 |
| TiO₂ | Titanium Dioxide | 0.2 | — |
| As | Arsenic | — | Trace < 0.1 |
| Sb | Antimony | — | Trace < 0.1 |
| Ni | Nickel | — | Trace < 0.1 |
| Balance | | Trace | Trace |

Although Myranite as sampled has been found to have a ferric content generally over 25% by weight it is possible that it might be as low as 20%. Furthermore it is possible that other ferromagnetic materials such as [Ni (en)₂]₃ [Fe(CN)₆]₂. 2H₂O could form at least a part of the iron content. The silica content may be as low as 20%.

Test equipment according to FIG. 4 was then connected to the device FIG. 1. The signal generated, Rohde L. Schwarz SMC RF generator, provided an un-modulated signal of 0 dBm amplitude at each test frequency. The frequency range was 1-1000 MHz as shown in FIG. 8. The level of the signal passing trough the co-axial cavity was measured by a Hewlett Packard HP8526A Spectrum Analyser and the data stored. The equipment was in accordance with ASTM D 4935

The Myranite powder of Table 1, suitably coated with either one or two metallic layers was typically of a density of about 3.5 g/ml and was found to be below measurement threshold for Alpha particle emission between 1 and 8 MeV when taken over thousands of hours.

The test samples were formed from coated Myranite powder, the coating to thicknesses of 1 to 2 micron and 2 to 3 micron, being copper but other coatings may be used such as chromium, nickel, aluminium, zinc, neodymium, gold, silver and strontium ferrite. The coating improves the shielding performance over un-coated powder very considerably. The coating may be applied in multi-layers by a dry blending process, plasma coating, electrolysis or electroless plating.

The Myranite powder may be heat treated and may be compounded and cold blended with polymers, resins and elastomers to at least 92% by weight. Samples tested were between 50% and 92% by weight. Particle sizes in the test samples have been between 10 and 180 microns.

A typical test result shown in FIG. 8 shows a 4 mm test sample of FIG. 2 resulted in a reduction of electro-magnetic emissions of 40 dB for just below 150 MHz and over 50 dB for 350-1000 MHz. The samples tried were considered to be highly useful in shielding emissions from electronic components in mobile phones.

In order to reduce the cost of shielding and/or where a lower efficiency can be accepted the powdered material of the invention may be mixed with uncoated ferrosilicates.

A typical Myranite compound used in trials to produce high performance injection moulded components according to the invention was:
15% resin
8% hardener
1.5% brominated organic flame retardant
0.1-0.2% accelerator
0.7% inorganic flame retardant
0.3% coupling agent
0.15% release agent
0.15% carbon black pigment
74% copper coated Myranite powder

The Myranite powder used in successful trials was generally less than 200 micron particle size and separated into four powder sizes (0−50, 50−100, 100−150 and 150+microns). Trials showed that the Myranite powder performed well as a filler with no tendency to cause delamination. The Myranite compound was used for micro-packaging (see FIG. 6) and for a windscreen wiper motor housing indicating its excellent performance for micro circuitry and for automotive components. The Myranite filler may be between 70 an 80% by weight.

In the micro-packaging application that was subjected to trial, an integrated circuit chip was encapsulated in a Myranite compound similar to that above to form a Quad Flat Pack (QFP) and compared with a standard QFP using conventional silica fillers(Dexter Hysol compound). Myranite QFP,s according to the invention were tested for 240 hours (equivalent to 40 years use in temperate climates) in a highly accelerated stress test (HAST) chamber at 108 degrees C. and 90% relative humidity (RH). There were no failures of the Myranite QFP's after 240 hours. The electrical performance was found to be nearly identical to a standard IC in a standard QFP.

After initial problems with poorly coated samples of Myranite powder, electromagnetic (EM) screening provided by Myranite compounds as described above proved to be extremely effective—see FIGS. 9 and 10 for Samples 325 (Teesside sample 2) and Sample 326 (Teesside sample 3). This may be compared with a sample (327) (Teesside sample 4) as shown in FIG. 11 which used a standard known Dexter Hysol compound.

Care was taken when compounding Myranite compounds to avoid the effects of shear which car strip copper off coated Myranite powder and trials showed that mill rollers had to be set with a wide gap to avoid reduction in EM screening effectiveness.

On completion of the trials it was found that in almost every respect, Myranite is an ideal low cost filler in compounds for transfer moulding of micro-electronics packaging. It is electrically, physically, chemically, mechanically and radioactively a good solution Myranite also compounds well, is mouldable and disperses uniformly. Components transfer moulded only with Myrane filled compounds, show comparable amounts of delamination to those of standard resins. Final tests resulted in EM shielding by as much as 90 dB over a full spectrum without any short circuiting of the standard micro-electronics device used in the tests.

Trials on electrical motor housings for windscreen wipers (FIG. 12) had to be curtailed due to pressures on the trial's team. However, initial indications are that Myranite compounds are highly suitable apart from their excellent EM shielding (EMS) performance since motor stators can be moulded directly into the Myranite compound casing thereby avoiding the necessity of metal canning. Further, because the screening material is throughout the casing, drainage by scratching or whatever to the outside of the casing does not effect its EMS performance.

Initial tests on Myranite compounds indicate its suitability for plating with metal for reflective or decorative purposes. The mechanical properties when used in larger casings than that shown in FIG. 12 appear to provide a very attractive material.

Trials on Myranite included in an elastomeric material have been indicated by the Applicant but are not yet completed.

1. A filler for plastics or elastomeric materials comprising a powder having a ferromagnetic material content greater than 20% by weight and a silica content greater than 20% by weight, the powder being coated with an electro-conductive metallic material.

2. The filler of claim 1 wherein the ferromagnetic material is FeO, Fe₂O₃ or Fe₃O₄.

3. The filler of claim 1 wherein the ferromagnetic material content is 25% to 50% by weight.

4. The filler of claim 1 wherein the silica content is 25% to 50% by weight.

5. The filler of claim 1 wherein the particle size of the powder is generally below 200 microns.

6. The filler of claim 1 wherein the electro-conductive metallic material is copper, nickel or chromium.

7. The filler of claim 1 wherein the electro-conductive metallic coating is between 0.5 microns and 4 microns thick.

8. A plastics material suitable for moulding comprising at least a resin and hardener and between 50% and 92% by weight of the filler of claim 1.

9. A plastics material as claimed in claim 8 wherein the filler content is between 70% and 80% by weight.

10. An elastomeric material containing the filler of claim 1.

11. An electrical or electronic component shielded, packaged or encapsulated in the material of claim 8.

12. A component as claimed in claim 1 1 being an integrated chip.

13. A component as claimed in claim 1 1 being an electric motor.

14. (canceled)

15. (canceled)

16. (canceled)

17. A method of forming a product by compounding the filler of claim 1 with at least a resin and hardener and moulding the resultant compound.

18. A method of forming a product as claimed in claim 17 including the further step of plating the moulded compound.

19. (canceled)
